(19) United States
(12) Patent Application Publication
(10) Pub. No.: US 2013/0133595 A1
(43) Pub. Date: May 30, 2013

(54) ANCILLARY DEVICE FOR ENHANCING ENGINE FUEL COMBUSTION EFFICIENCY

(71) Applicant: WEN-LO CHEN, Taipei City (TW)

(72) Inventor: WEN-LO CHEN, Taipei City (TW)

(21) Appl. No.: 13/304,309

(22) Filed: Nov. 24, 2011

(51) Int. Cl. F02B 43/02

(52) U.S. Cl. 123/3

(57) ABSTRACT

An ancillary device for enhancing engine fuel combustion efficiency includes a pure water replenishable electrolytic bath and a hydrogen-oxygen fuel cell installed on an automobile. The electrolytic bath and the hydrogen-oxygen fuel cell are electrically connection with an automobile battery The battery supplies electrical power to the electrolytic bath to electrolyze water replenished thereto into hydrogen and oxygen, which are fed through a first gas supply tube into an automobile fuel conduit to mix with fuel for being supplied with the fuel to an engine cylinder. The hydrogen and oxygen are also supplied through a second gas supply tube to the hydrogen-oxygen fuel cell for chemical reaction that generates electrical power to charge the battery. The chemical reaction of the hydrogen-oxygen fuel cell generates a product of pure water that is supplied through a pure water tube to the electrolytic bath for circulative and cyclic use for electrolysis.

### TECHNICAL FIELD OF THE INVENTION

The present invention generally relates to ancillary device that generates auxiliary fuel to be supplied to an existing fuel supply system of an automobile for being fed to an engine cylinder in order to reduce the original fuel consumption, increase fuel combustion efficiency, and generate electrical power in an operation cycle to charge an automobile battery and recover the produced pure water for circulative and cyclic use.

### DESCRIPTION OF THE PRIOR ART

The traditional gasoline engine or diesel engine emits exhaust gases in their operations, and this cause severe pollution to the atmosphere and leads to global greenhouse effect. The diesel engine, during operation, generates various gaseous, liquid, and solid contaminants, and also discharges various gaseous pollutants, such as carbon monoxide (CO), sulfur oxides (SOₓ), carbon dioxide (CO₂), and hydrocarbons (HC), which lead to damage to the global ecologic environment, such as deteriorating the Ozonosphere, causing acid rain, and increasing greenhouse effect and are harmful to health. For example, nitrogen oxides may be converted to nitric acid, which causes acid rain and also damage the ozonosphere, and may generate photochemical smog once being acted upon by sun light. Particle pollutants or smokes contain polycyclic aromatic hydrocarbons (PAHs) or metal compounds that cause sickness of human lungs, windpipes, and respiratory tracts. The gasoline engine, although not making such a significant pollution as the diesel engine does, still emits toxicant substances, such as hydrocarbons, which are hazardous to human body and the environments.

Various solutions have been proposed in the automobile industry. For example, a filter system is arranged in the exhaust pipe of an automobile engine in order to filter the exhaust gas discharged from the automobile engine. However, the essential environmental protection problem that a great amount of fossil fuel is being consumed by the automobiles remains unaddressed. Further, electrical vehicles, hybrid vehicles, or solar power vehicles are currently being under development in the automobile industry However, no breakthrough technique has been proposed for battery so that the typical problems regarding to storage capacity, charging speed, and excessive weight of the battery are not yet overcome. This makes the electrical vehicle, the hybrid vehicles, or the solar energy vehicles expensive and cannot be popularized.

The diesel engine and gasoline engine that are current available have a combustion efficiency between around 15% to 28% and incomplete combustion leads to emission of toxicant exhaust gases, such as smoke (for example CO), suspension particles (PM2.5-10), hydrocarbons (HC), nitrogen oxides (NOₓ), odors. This affects the human health and is also important factors that cause global warming and change of weather.

The present invention aims to provide a solution to the problem that the combustion efficiency of the conventional vehicles cannot be easily improved, causing emission of exhaust that contains high contents of pollutant components and generating smokes, and being impossible lower fuel consumption.

### SUMMARY OF THE INVENTION

The feature of the present invention is to install a pure water replenishable electrolytic bath and a hydrogen-oxygen fuel cell on an automobile. The electrolytic bath and the hydrogen-oxygen fuel cell are individually in electrical connection with an automobile battery The battery supplies electrical power to the electrolytic bath to allow the electrolytic bath to electrolyze the pure water replenished thereto into hydrogen and oxygen. The hydrogen and oxygen are fed through a first gas supply tube into an automobile fuel conduit to mix with fuel and thus supplied together with the fuel to a cylinder of an automobile engine. The hydrogen and oxygen are also supplied through the second gas supply tube to the hydrogen-oxygen fuel cell for chemical reaction that generates electrical power to charge the battery The chemical reaction of the hydrogen-oxygen fuel cell generates a product of pure water that is supplied through a pure water tube to the electrolytic bath for circulative and cyclic use for electrolysis. A user does not need to frequently replenish pure water to the electrolytic bath so that the convenience of use is improved.

The technical solution of the present invention comprises a hydrogen-oxygen fuel cell and a pure water replenishable electrolytic bath. The electrolytic bath and the hydrogen-oxygen fuel cell are both electrically connected to a battery of an automobile. The electrolytic bath is connected to a first gas supply tube. The first gas supply tube is in communication with an automobile fuel conduit. The hydrogen-oxygen fuel cell is connected through a second gas supply tube to the first gas supply tube and is connected through a pure water tube to the electrolytic bath. As such, the battery supplies electrical power to the electrolytic bath to allow the electrolytic bath to electrolyze pure water replenished thereto into hydrogen and oxygen. The hydrogen and oxygen are fed through the first gas supply tube into the fuel conduit to mix with fuel and thus supplied together with the fuel to a cylinder of an automobile engine. The hydrogen and oxygen are also supplied through the second gas supply tube to the hydrogen-oxygen fuel cell to allow the hydrogen-oxygen fuel cell to perform a chemical reaction that generates electrical power to charge the battery. The chemical reaction of the hydrogen-oxygen fuel cell generates a product of pure water that is supplied through the pure water tube to replenish the electrolytic bath. In other words, the pure water is automatically replenished into the electrolytic bath from time to time for circulative and cyclic use for electrolysis. A user does not need to watch the water level of the electrolytic bath for manual replenishment.

The ancillary device of the present invention is operated under the control of an automobile computer and automatically activates or deactivates the electrolytic bath at the time when the automobile power supply is activated or cut off. When the electrolytic bath is activated, DC voltage and electrical current are automatically regulated to control the speed of generating hydrogen and oxygen for supply the hydrogen and oxygen to the fuel conduit and the hydrogen-oxygen fuel cell.

In the operation of electrolysis of pure water, the ancillary device according to the present invention needs only to stably control voltage and current in order to control the speed of generation of hydrogen and oxygen that are fed, under negative pressure (siphon effect), continuously into the fuel pipe to be mixed with a mixture gas of fuel for being collectively supplied into an engine combustion chamber to be combusted therein so as to acquire improved combustion efficiency.

The present invention uses the battery that is set up in an automobile to supply electrical power that is required by the electrolytic bath and due to the increase of combustion efficiency, the power generation performance of dynamo can be improved to fast charge electrical power into the battery.

The present invention provides a throttle valve and a check valve in the first gas supply tube and when the electrical power is cut off, the throttle valve is automatically closed to cut off the supplies of hydrogen and oxygen, and when power is set on, the check valve helps preventing the fuel to flow through the gas supply tube into the electrolytic bath.

The present invention provides a flowrate controller in the pure water tube to control the flowrate of pure water that is produced by the chemical reaction of the hydrogen-oxygen fuel cell supplied to the electrolytic bath.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is schematic view illustrating an application of the present invention in an automobile fuel supply system.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

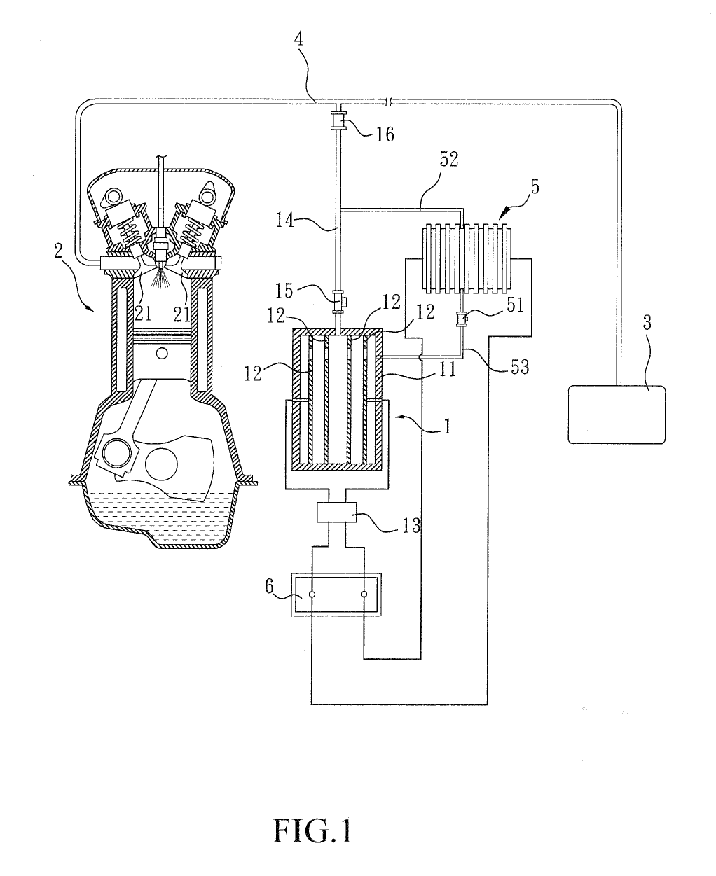

FIG. 1 is schematic view illustrating an ancillary device according to the present invention applied to an automobile fuel supply system. The feature comprises an electrolytic bath 1 and a hydrogen-oxygen fuel cell 5 mounted at suitable locations on an automobile. The electrolytic bath 1 has a bath tank 11 in which a plurality of plates 12 for chemical reaction to cause electrolysis. The electrolytic bath 1 is electrically connected via a transformer 13 to a battery 6 arranged on the automobile. A regular automobile battery has a voltage level of 12V (volts), which voltage is reduced by the transformer 13 to 6V (volts) to be supplies to the electrolytic bath 1 for chemical reaction of electrolysis. The bath tank 11 of the present invention is connected to at least one first gas supply tube 14. The first gas supply tube 14 is connected to a fuel conduit of the automobile, such as a fuel pipe 4 or a fuel gas pipe. The first gas supply tube 14 is also provided with a throttle valve 15 and a check valve 16. The fuel pipe 4 is connected to a fuel tank 3 and an engine 2. The hydrogen-oxygen fuel cell 5 is electrically connected to the battery 6, and is connected via a second gas supply tube 52 to the first gas supply tube 14 and is also connected by a pure water tube 53 to the electrolytic bath 1. The pure water tube 53 is provided, at a suitable location, with a flowrate controller 51 to the water flowrate from the hydrogen-oxygen fuel cell 5 to the electrolytic bath 1. When electrical power is cut off, the present invention automatically closes the throttle valve 15 to cut off the supplies of hydrogen and oxygen; and when power is set on, the check valve 16 helps preventing the fuel to flow through the gas supply tube 14 into the electrolytic bath 1.

The present invention is operated under the control of an automobile computer and automatically activates or cuts off electrical power supplied to the electrolytic bath 1 at the time when the automobile power supply is activated or cut off. When the electrolytic bath 1 is activated, DC voltage and electrical current are automatically regulated to control the speed of generating hydrogen and oxygen through electrolysis. When the supply of pure water is insufficient, an alarm is automatically issued and electrical power is cut off. When pure water is sufficiently replenished, the electrical power is automatically re-activated. In the operation of electrolysis of pure water, the ancillary device according to the present invention needs only to stably control voltage and current in order to control the speed of generation of hydrogen and oxygen that are fed, under negative pressure (siphon effect), continuously into the fuel pipe 4. The hydrogen and oxygen fed into the fuel pipe 4 are mixed with a mixture gas of fuel and collectively supplied through valve 21 into a combustion chamber of the engine 2 to be combusted therein. For an automobile, hydrogen can be quickly ignited in around one tenth second, and this, together with the combustion supporting effect provide by oxygen, allows the hydrogen and oxygen contained fuel mixture to be combusted in the combustion chamber of the engine cylinder to acquire an improved combustion efficiency and an increase of output power and reduce the generation of various toxicant exhaust gases and odors. Namely a smaller amount of fuel may provide the desired combustion performance and power so that the consumption of fuel is reduced and the cost of fuel is lowered.

The hydrogen and oxygen generated by the electrolysis reaction of the electrolytic bath 1, when flowing through the first gas supply tube 14, is allowed to flow through the second gas supply tube 52 into the hydrogen-oxygen fuel cell 5 for carrying out chemical reactions for generation of electrical power. The electrical power so generated is fed to and accumulated in the battery 6. The chemical reaction of the hydrogen-oxygen fuel cell 5 generates a product of pure water that is supplied through the pure water tube 53 to the electrolytic bath 1 for circulative and cyclic use. Proper operation of the flowrate controller 51 can be done to regulate the flowrate of pure water into the electrolytic bath 1. In other words, the electrolytic bath 1 can be automatically replenished with pure water and manual intervention for pure water replenishment can be significantly reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An ancillary device for enhancing fuel combustion efficiency of engine comprising a pure water replenishable electrolytic bath, the electrolytic bath being electrically connected to a battery, the electrolytic bath being connected to a first gas supply tube, the first gas supply tube being in communication with an automobile fuel conduit;
a hydrogen-oxygen fuel cell, which is connected through a second gas supply tube to the first gas supply tube and is connected through a pure water tube to the electrolytic bath, the hydrogen-oxygen fuel cell being electrically connected to an automobile power source;
the battery supplying electrical power to the electrolytic bath to allow the electrolytic bath to electrolyze pure water replenished thereto into hydrogen and oxygen, the hydrogen and oxygen being fed through the first gas supply tube into the fuel conduit to mix with fuel and thus supplied together with the fuel to a cylinder of an automobile engine, the hydrogen and oxygen being also supplied through the second gas supply tube to the hydrogen-oxygen fuel cell for chemical reaction that generates electrical power to charge the battery, the chemical reaction of the hydrogen-oxygen fuel cell generating a product of pure water that is supplied through the pure water tube to replenish the electrolytic bath.

2. The ancillary device for enhancing fuel combustion efficiency of engine according to claim 1, wherein the pure water tube comprises a flowrate controller mounted thereto.
